(19) United States
(12) Patent Application Publication
(10) Pub. No.: US 2021/0150769 A1
(43) Pub. Date: May 20, 2021

(54) HIGH EFFICIENCY IMAGE AND VIDEO COMPRESSION AND DECOMPRESSION

(71) Applicant: QUALCOMM Incorporated, San Diego, CA (US)

(72) Inventor: Parisa BABAHEIDARIAN, Acton, MA (US)

(21) Appl. No.: 16/858,456

(22) Filed: Apr. 24, 2020

Related U.S. Application Data
(60) Provisional application No. 62/935,274, filed on Nov. 14, 2019.

(51) Int. Cl. G06T 9/00; H04N 19/136; H04N 19/13; H04N 19/172; H04N 19/85; G06K 9/62; G06N 3/02

(52) U.S. Cl. CPC G06T 9/002; H04N 19/136; H04N 19/13; G06K 9/6257; H04N 19/85; G06K 9/6265; G06N 3/02; H04N 19/172

(57) ABSTRACT

Systems, methods, and computer-readable media are provided for high efficiency compression and decompression. An example method can include receiving, by a deep postprocessing network, a lower entropy image including a first version of a source image, the lower entropy image having a reduced entropy relative to the source image and a compressed state relative to the source image; decompressing the lower entropy image; identifying, by a generator network of the deep postprocessing network, a first set of style information having a similarity to a second set of style information missing from the lower entropy image, the second set of style information including style information included in the source image and removed from the lower entropy image; and generating, by the generator network of the deep postprocessing network, a higher entropy image including the lower entropy image modified to include the first set of style information.

### CROSS-REFERENCE TO RELATED APPLICATIONS

This application claims the benefit of, and priority to, U.S. Provisional Patent Application No. 62/935,274 filed on Nov. 14, 2019, entitled “HIGH EFFICIENCY IMAGE AND VIDEO COMPRESSION AND DECOMPRESSION”, the contents of which are hereby expressly incorporated by reference in their entirety.

### TECHNICAL FIELD

The present disclosure generally relates to image and video compression and decompression.

### BACKGROUND

The increasing versatility of image sensors has allowed image and video recording capabilities to be integrated into a wide array of devices. Users can capture video, images, and/or audio from any device equipped with such image sensors. The video, images, and audio can be captured for recreational use, professional use, surveillance, and automation, among other applications. In some cases, devices can capture media data, such as images or videos, and generate files or streams containing the media data. The media data can be streamed or transmitted to a receiving device for presentation at the receiving device. Given the high bandwidth requirements of certain media data, such as online video games or streamed videos, and the amount of bandwidth available by network communication channels, the receiving users often experience latency in the streamed or transmitted media data. Such latency can negatively impact the experience of users receiving such media data, and even limit the media data that can be consumed by end users.

### BRIEF SUMMARY

Disclosed are systems, methods, and computer-readable media for high efficiency image and video compression and decompression. According to at least one example, a method is provided for high efficiency image and video compression and decompression. The method can include receiving, by a deep postprocessing network, a lower entropy image including a first version of a source image, the lower entropy image having a reduced entropy relative to the source image and a compressed state relative to the source image; decompressing the lower entropy image; identifying, by a generator network of the deep postprocessing network, a first set of style information having a similarity to a second set of style information missing from the lower entropy image, the second set of style information including style information included in the source image and removed from the lower entropy image; and generating, by the generator network of the deep postprocessing network, a higher entropy image including the lower entropy image modified to include the first set of style information.

According to at least one example, an apparatus is provided for high efficiency image and video compression and decompression. The apparatus can include memory and one or more processors coupled to the memory, the one or more processors being configured to receive, by a deep postprocessing network, a lower entropy image including a first version of a source image, the lower entropy image having a reduced entropy relative to the source image and a compressed state relative to the source image; decompress the lower entropy image; identify, by a generator network of the deep postprocessing network, a first set of style information having a similarity to a second set of style information missing from the lower entropy image, the second set of style information including style information included in the source image and removed from the lower entropy image; and generate, by the generator network of the deep postprocessing network, a higher entropy image including the lower entropy image modified to include the first set of style information.

According to at least one example, another apparatus is provided for high efficiency image and video compression and decompression. The apparatus can include means for receiving, by a deep postprocessing network, a lower entropy image including a first version of a source image, the lower entropy image having a reduced entropy relative to the source image and a compressed state relative to the source image; decompressing the lower entropy image; identifying, by a generator network of the deep postprocessing network, a first set of style information having a similarity to a second set of style information missing from the lower entropy image, the second set of style information including style information included in the source image and removed from the lower entropy image; and generating, by the generator network of the deep postprocessing network, a higher entropy image including the lower entropy image modified to include the first set of style information.

According to at least one example, a non-transitory computer-readable storage medium is provided for high efficiency image and video compression and decompression. The non-transitory computer-readable storage medium can include instructions stored thereon which, when executed by one or more processors, cause the one or more processors to receive, by a deep postprocessing network, a lower entropy image including a first version of a source image, the lower entropy image having a reduced entropy relative to the source image and a compressed state relative to the source image; decompress the lower entropy image; identify, by a generator network of the deep postprocessing network, a first set of style information having a similarity to a second set of style information missing from the lower entropy image, the second set of style information including style information included in the source image and removed from the lower entropy image; and generate, by the generator network of the deep postprocessing network, a higher entropy image including the lower entropy image modified to include the first set of style information.

In some aspects, the method, non-transitory computer-readable medium, and apparatuses described above can include classifying, by a discriminator network of the deep postprocessing network, the higher entropy image as a real image or a fake image. In some aspects, the method, non-transitory computer-readable medium, and apparatuses described above can include outputting, when the higher entropy image is classified as the real image, the higher entropy image.

In some aspects, the method, non-transitory computer-readable medium, and apparatuses described above can include generating, by the generator network, a new higher entropy image when the higher entropy image is classified as the fake image, the new higher entropy image including the lower entropy image modified to include a third set of style information having a further similarity to the second set of style information missing from the lower entropy image; and classifying, by the discriminator network, the new higher entropy image as the real image or the fake image.

In some examples, the style information can include color information, texture information, image temperature information, information about one or more image edges, background image data, illumination information, and/or one or more visual image details.

In some examples, identifying the first set of style information having the similarity to the second set of style information can include learning the first set of style information from one or more different images, and generating the higher entropy image can include adding the first set of style information learned from the one or more different images to the lower entropy image.

In some examples, identifying the first set of style information having the similarity to the second set of style information can include learning the first set of style information from one or more different images, the first set of style information being learned without reference to the source image and/or interacting with an encoder that coded at least one of the source image and the lower entropy image.

In some examples, generating the higher entropy image can include increasing an entropy of the lower entropy image by adding the first set of style information to the lower entropy image, wherein the first set of style information is learned by analyzing a dataset of images having one or more statistical properties selected based on one or more properties of the lower entropy image.

In some aspects, the method, non-transitory computer-readable medium, and apparatuses described above can include obtaining, by a steganography encoder network of a preprocessing network, the source image and a cover image; generating, by the steganography encoder network, a steganography image including the cover image with the source image embedded in the cover image, the source image being at least partly visually hidden within the cover image; extracting, by a steganalysis decoder network of the preprocessing network, the source image from the steganography image; and generating, by the steganalysis decoder network, the lower entropy image based on the source image.

In some examples, generating the lower entropy image can include removing the second set of style information from the source image, wherein the steganalysis decoder network includes a neural network, and wherein the neural network generates the lower entropy image using a steganalysis algorithm.

In some aspects, the method, non-transitory computer-readable medium, and apparatuses described above can include compressing the lower entropy image after generating the lower entropy image; and sending the compressed lower entropy image to the deep postprocessing network.

In some aspects, the apparatuses described above can include one or more sensors and/or a mobile device. In some examples, the apparatuses described above can include a mobile phone, a wearable device, a display device, a mobile computer, a head-mounted device, and/or a camera.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

In order to describe the manner in which the above-recited and other advantages and features of the disclosure can be obtained, a more particular description of the principles described above will be rendered by reference to specific embodiments thereof which are illustrated in the appended drawings. Understanding that these drawings depict only example embodiments of the disclosure and are not to be considered to limit its scope, the principles herein are described and explained with additional specificity and detail through the use of the drawings in which:

FIG. 1 illustrates an example architecture of an image processing system that can implement high efficiency image and video compression and decompression, in accordance with some examples of the present disclosure;

FIG. 3A illustrates an example system flow implemented by a deep preprocessing network for high efficiency compression of image data, in accordance with some examples of the present disclosure;

FIG. 3B illustrates an example system flow implemented by a deep postprocessing network for high efficiency decompression of image data, in accordance with some examples of the present disclosure;

FIG. 4 illustrates an example high efficiency compression and decompression flow, in accordance with some examples of the present disclosure;

FIG. 5 illustrates an example configuration of a neural network that can be implemented by one or more components of a deep preprocessing network and/or a deep postprocessing network for high efficiency compression and decompression, in accordance with some examples of the present disclosure;

FIG. 6 illustrates example lower entropy target images generated by a deep preprocessing network and example higher entropy target images generated by a deep postprocessing network based on the example lower entropy target images, in accordance with some examples of the present disclosure;

FIG. 7A illustrates an example method for high efficiency decompression, in accordance with some examples of the present disclosure;

FIG. 7B illustrates an example method for high efficiency compression, in accordance with some examples of the present disclosure; and

FIG. 8 illustrates an example computing device architecture, in accordance with some examples of the present disclosure.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

In streaming and online content applications, reducing the latency and bandwidth requirements of content delivered over a network can be a significant benefit as it can allow seamless streaming and delivery of media content such as online videos and games. For example, even small amounts of lag can have a noticeable, detrimental performance impact in online gaming applications. Thus, reducing latency and bandwidth requirements can provide significant advantages and improvements in streaming and content delivery applications. To reduce latency and bandwidth requirements of network or online content, the approaches herein can significantly compress the content and thereby reduce the size or amount of data transmitted over the network.

In some examples, the disclosed technologies provide high efficiency media content (e.g., images, videos, etc.) compression and decompression. The high efficiency media content compression and decompression algorithms can reduce the latency and bandwidth requirements of media content delivered over a communication channel, such as videos and images delivered over a network. In some cases, example high efficiency image and video compression and decompression technologies disclosed herein can implement deep neural processing networks for image and video compression and decompression, in conjunction with other compression and decompression techniques such as Discrete Cosine Transform (DCT), Joint Photographic Experts Group (JPEG) compression and decompression, or any other compression and decompression techniques.

In some aspects, a high efficiency image and video compression and decompression system can include a deep preprocessing network and a deep postprocessing network. In some examples, the preprocessing network can include a steganography encoder, a steganalysis decoder, and a compression encoder. Steganography is a science of embedding a secret message, such as an image, into a container message, such as a container image, without or with a low distortion of the container message. Moreover, steganalysis is the science of recovering the secret message from the container message without access to the stenography encoder.

In some examples, a steganography encoder of the high efficiency image and video compression and decompression system can be implemented using one or more deep neural networks that can embed a target (or source) image to be transmitted over a communication channel in a reduced size, into a cover (or container) image to generate a steganography image that combines the cover image and the secret image. The target image can be invisible to the end user, but can be extracted from the cover image using a steganalysis decoder in the preprocessing network. The steganalysis decoder can be implemented using one or more deep neural networks configured to recover the target image embedded in the cover image.

In some examples, the target image can be a higher entropy image, which the steganalysis decoder can use along with the steganography encoder (which uses the cover image) to generate a lower entropy image, which can be a version of the target image having a lower entropy. The lower entropy image can be represented by a fewer number of bits than the higher entropy target image, thus reducing the latency and bandwidth requirements of the lower entropy image when transmitted over a communication channel to a receiving device.

Entropy is a measure of uncertainty (e.g., referred to as Shannon entropy in some cases) which, given a random variable X with possible outcomes xᵢ, each with a probability P_{X}(xᵢ), entropy can be defined as −Σᵢ P_{X}(xᵢ) log Pₓ(xᵢ). In the present context, entropy can include the measure of image information content in an image and/or the amount of uncertainty of image variables or components. For example, the entropy of an image can indicate the amount of information included in the image about the features or contents of the image (e.g., color, texture, edges, details, resolution, temperature, image background, illumination, etc.). Thus, an image with a lower entropy can have less information content (or less detailed information) than an image with a higher entropy, which in some cases can result in the image with the lower entropy having a lower quality than the image with the higher entropy.

In some examples, the steganography encoder of the deep preprocessing network can code the cover image with the target image while preserving spatial dependencies across neighboring pixels in the image data. The steganalysis decoder of the deep preprocessing network can process a container image, which includes the cover image and the target image, and extract a lower entropy version of the target image. The steganalysis decoder can then extract a lower entropy version of the target image. The lower entropy version of the target image can be a lower entropy image represented by a fewer number of bits than the original target image embedded in the cover image. Moreover, in some cases, the lower entropy image generated by the steganalysis decoder can be processed by a compression decoder that compresses the lower entropy image. The compression decoder can implement any compression technique such as, for example, DCT or JPEG.

In some cases, the cover image can be used as a parameter for tuning the deep preprocessing network (e.g., the steganography encoder and/or the steganalysis decoder). In some examples, the steganography encoder and the steganalysis decoder can be trained together to ensure that their final output has a reduced entropy. In some examples, the steganography encoder can be trained in several stages. For example, in a first stage of training, the steganography encoder can be trained with its matching steganalysis decoder. In some cases, after the first stage, only the steganography encoder is used. In the second stage, the steganalysis decoder can be trained along with a deep postprocessing network of the high efficiency compression and decompression system.

In some cases, the deep postprocessing network of the high efficiency compression and decompression system can include a transfer network, which can use receive the output from the preprocessing network (e.g., the lower entropy target image) to generate a higher entropy target image. In some cases, the output image from the preprocessing network may not include style information associated with the target image, which can help reduce the entropy of the output image and hence can reduce the transmission data rate of the output image when transmitted over a communication channel. Style information associated with an image (e.g., the target image) can include, for example, information about the appearance and/or visual style of the image, such as color information, texture information, edge information, information about image details, image background information, temperature information, illumination information, resolution information, dynamic range information, etc. In some examples, the higher entropy target image generated by the transfer network can be a version of the lower entropy target image having a higher entropy.

In some examples, the transfer network can include a deep steganalysis transfer decoder. In some cases, the transfer network can include a decompression decoder and a deep generative adversarial network (GAN). The decompression decoder can include a decompression algorithm that can match the encoder format (e.g., JPEG, DCT, etc.). The GAN can include a generator and a discriminator network. The generator can aim to produce the target image with a higher entropy, and the discriminator can be trained to label high entropy images produced by the generator as real or fake. In some examples, the discriminator can be trained to label higher entropy target images generated by the generator as either fake or real based on how realistic they appear. During the training stage, the generator can learn to produce higher entropy images that pass the discriminator's test for determining whether an image is real or fake.

In some examples, the transfer network of the deep postprocessing network can decompress the lower entropy target image from the deep preprocessing network, and use the lower entropy target image as input to generate a higher entropy target image, which can be a version of the lower entropy target image having a higher entropy. In some examples, the higher entropy target image generated by the transfer network can have a higher quality than the lower entropy target image used to generate the higher entropy target image. For example, the higher entropy target image can have more details, features, and/or image content information than the lower entropy target image. In some training examples, the transfer network of the deep postprocessing network can use a dataset of images having certain style information and a noise image (or noise vector) as training inputs to learn how to generate higher entropy images with such style information.

In some examples, to generate the higher entropy target image, the transfer network can learn a desired style or style information for the target image from a high entropy image dataset, such as a set of higher quality images, and transfer the desired style or style information to the target image generated by the transfer network. The images in the high entropy dataset can include, for example and without limitation, natural images, images of farm animals, images of landscapes, etc.

As previously noted, in some examples, the steganalysis decoder of the preprocessing network can remove side information from the target image, such as style information, which can reduce the size of the compressed target image and allow the compressed target image to achieve lower transmission rates. In some examples, style information removed from the target image can include information about the appearance and/or visual style of the target image, such as color, texture, edge, details, image background, temperature, illumination, resolution, etc. By removing the style information from the target image to reduce the size of the compressed target image, the compressed target image can be transmitted to a receiver's decoder at a lower transmission rate and with reduced latency and bandwidth utilization.

In some examples, using deep generative models trained on a dataset of high entropy versions of RGB (Red, Green, Blue) images that have similar statistical properties as the target image, the transfer network can learn high resolution style information for the target image without interacting with the steganography encoder. As a result, the preprocessing network does not need to transmit the style information of the target image to the transfer network, which allows lower transmission rates as previously noted.

In some examples, the approaches herein can reduce a compression rate of a target image without sacrificing or reducing the visual quality of the decompressed target image after it is processed by the deep postprocessing network. In some examples, the deep preprocessing network can reduce the entropy of a target image by manipulating the RGB channels in the image and creating a lower entropy target image. The postprocessing network can increase the entropy of the decompressed target image from the preprocessing network by adding back style information removed from the target image and, as a result, can produce a higher entropy target image which can be comparable to the original target image and/or can have a higher entropy than the target image from the preprocessing network.

As previously noted, the disclosed approaches can achieve entropy reduction by removing style information from target images. In some cases, by Shannon's source coding theorem, fewer bits may be used to encode the remaining information in the target image. For example, assume that a target image is denoted by X, the style information is denoted by S while T represents the remaining information (e.g., X=(T, S)). The following function illustrates an example entropy reduction using style information: H(X)=H(T, S)=H(T)+H(S|T)≥H(T). The deep preprocessing network and the deep postprocessing network can be trained simultaneously to achieve min H(T) and min ∥X−X′∥₂ where X′ is the decompressed target image after postprocessing of deep postprocessing network.

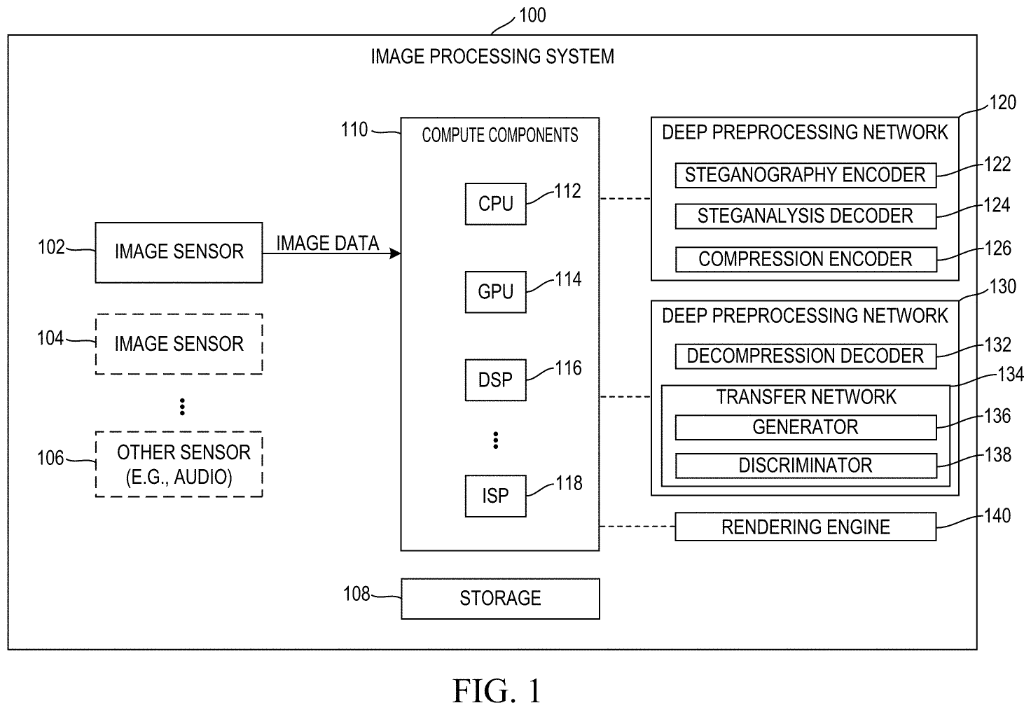

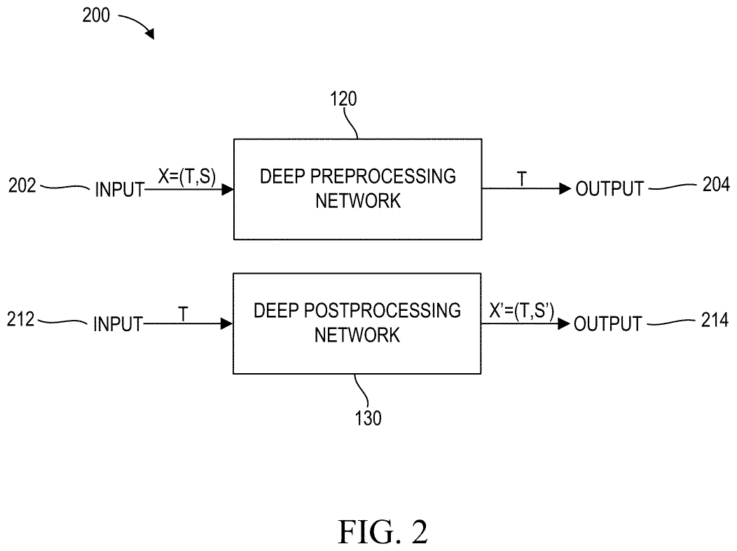

FIG. 1 illustrates an example architecture of an image processing system 100 that can implement high efficiency image and video compression and decompression as described herein. The image processing system 100 can perform various image and video processing tasks such as steganography and steganalysis operations, compression, and decompression, as further described herein. While steganography and steganalysis, compression, and decompression are described herein as example tasks that can be performed by the image processing system 100, it should be understood that the image processing system 100 can also perform other image and video processing tasks such as, for example, lens shading correction, downsampling, feature detection, blurring, segmentation, filtering, color correction, noise reduction, scaling, demosaicing, pixel interpolation, image signal processing, image enhancement, color space conversion, any combination thereof, and/or any other image and video processing operations.

In some cases, the image processing system 100 can code frames (e.g., image frames, video frames, etc.) to generate an encoded image and/or video bitstream. In some examples, the image processing system 100 can encode image data using a coding standard or protocol as well as other techniques such as steganography, as further described herein. Example coding standards include JPEG, DTC, ITU-T H.261; ISO/IEC MPEG-1 Visual; ITU-T H.262 or ISO/IEC MPEG-2 Visual; ITU-T H.263; High-Efficiency Video Coding (HEVC); ISO/IEC MPEG-4 Visual and ITU-T H.264 (also known as ISO/IEC MPEG-4 AVC), including its Scalable Video Coding (SVC) and Multiview Video Coding (MVC) extensions; various extensions to HEVC which deal with multi-layer coding and have been (or are being) developed, including the multiview extension to HEVC called MV-HEVC and the scalable extension to HEVC called SHVC; or any other suitable coding protocol.

Some aspects described herein describe example compression and decompression tasks performed by the image processing system 100 using the JPEG and DTC techniques. However, these example techniques are provided herein for illustrative purposes. The technologies described herein may also or alternatively implement other coding techniques, such as AVC, MPEG, extensions thereof, or other suitable coding standards available or not yet available or developed. Accordingly, while the systems and technologies described herein may be described with reference to particular coding standards and/or compression and decompression techniques, one of ordinary skill in the art will appreciate that the description should not be interpreted to apply only to those particular standards or compression and decompression techniques.

Moreover, the high efficiency compression and decompression technologies described herein are applicable to various media applications, such as media (e.g., image, video, etc.) streaming applications (e.g., over the Internet and/or a network), television broadcasts or transmissions, coding digital media (e.g., image, video, etc.) for storage on a data storage medium, online video gaming, and/or any other media applications. In some examples, the image processing system 100 can support one-way or two-way media (e.g., image, video, etc.) transmissions for applications such as video conferencing, video streaming, video playback, media broadcasting, gaming, video telephony, etc.

The image processing system 100 can be part of a computing device or multiple computing devices. For example, the image processing system 100 can be part of one or more electronic devices such as a camera system (e.g., a digital camera, an Internet Protocol camera, a video camera, a security camera, etc.), a phone system (e.g., a smartphone, a cellular telephone, a conferencing system, etc.), a personal computer (e.g., a laptop or notebook computer, a desktop computer, a tablet computer, etc.), a media server, a television, a gaming console, a video streaming device, a robotic device, an IoT (Internet-of-Things) device, a smart wearable device, an extended reality (e.g., virtual reality, augmented reality, mixed reality, etc.) device, a computer in an autonomous system (e.g., a computer in an autonomous vehicle, etc.), or any other suitable electronic device(s).

In the example shown in FIG. 1, the image processing system 100 includes an image sensor 102, storage 108, compute components 110, a deep preprocessing network 120, a deep postprocessing network 130, and a rendering engine 140. The image processing system 100 can also optionally include one or more additional image sensors 104 and/or one or more other sensors 106, such as an audio sensor or a light emitting sensor. For example, in dual camera or image sensor applications, the image processing system 100 can include front and rear image sensors (e.g., 102, 104). Moreover, the deep preprocessing network 120 can include a steganography encoder 122, a steganalysis decoder 124, and a compression encoder 126. The deep postprocessing network 130 can include a decompression decoder 132 and a transfer network 134. The transfer network 134 can include a GAN including a generator 136 and a discriminator 138.

In some implementations, the image sensor 102, the image sensor 104, the other sensor 106, the storage 108, the compute components 110, the deep preprocessing network 120, the deep postprocessing network 130, and the rendering engine 140 can be part of the same computing device. For example, in some cases, the image sensor 102, the image sensor 104, the other sensor 106, the storage 108, the compute components 110, the deep preprocessing network 120, the deep postprocessing network 130, and the rendering engine 140 can be integrated into a smartphone, personal computer, smart wearable device, gaming system, media server, media streaming device, mobile device, and/or any other computing device. However, in some implementations, the image sensor 102, the image sensor 104, the other sensor 106, the storage 108, the compute components 110, the deep preprocessing network 120, the deep postprocessing network 130, and/or the rendering engine 140 can be part of two or more separate computing devices.

The image sensors 102 and 104 can be any image and/or video sensors or capturing devices, such as a digital camera sensor, a video camera sensor, a smartphone camera sensor, an image/video capture device on an electronic apparatus such as a television or computer, a camera, etc. In some cases, the image sensors 102 and 104 can be part of a camera or computing device such as a digital camera, a video camera, an IP camera, a smartphone, a smart television, a game system, etc. In some examples, the image sensor 102 can be a rear image sensor system (e.g., a camera, a video and/or image sensor on a back or rear of a device, etc.) and the image sensor 104 can be a front image sensor system (e.g., a camera, a video and/or image sensor on a front of a device, etc.). In some examples, the image sensors 102 and 104 can be part of a dual-camera assembly. The image sensors 102 and 104 can capture image and/or video content (e.g., raw image and/or video data), which can then be processed by the compute components 110, the deep preprocessing network 120, the deep postprocessing network 130, and/or the rendering engine 140, as further described herein.

The other sensor 106 can be any sensor for detecting or measuring information such as sound, light, distance, motion, position, temperature, etc. Non-limiting examples of sensors include audio sensors, light detection and ranging (LIDAR) devices, lasers, gyroscopes, accelerometers, and magnetometers. In some cases, the image processing system 100 can include other sensors, such as a machine vision sensor, a smart scene sensor, a speech recognition sensor, an impact sensor, a position sensor, a tilt sensor, a light sensor, etc.

The storage 108 can be any storage device(s) for storing data, such as image data (e.g., images, videos), metadata, logs, user data, files, software, etc. Moreover, the storage 108 can store data from any of the components of the image processing system 100. For example, the storage 108 can store data or measurements from any of the sensors 102, 104, 106, data from the compute components 110 (e.g., processing parameters, output data, calculation results, etc.), and/or data from any of the deep preprocessing network 120, the deep postprocessing network 130, and/or the rendering engine 140 (e.g., output images, rendering results, etc.).

In some implementations, the compute components 110 can include a central processing unit (CPU) 112, a graphics processing unit (GPU) 114, a digital signal processor (DSP) 116, and/or an image signal processor (ISP) 118. The compute components 110 can perform various operations such as compression, decompression, steganography, steganalysis, image and/or video generation, classification, image and/or video enhancement, object or image segmentation, computer vision, graphics rendering, image processing, sensor data processing, recognition (e.g., face recognition, text recognition, object recognition, feature recognition, tracking or pattern recognition, scene recognition, etc.), machine learning, filtering, and/or any of the various operations described herein. In some examples, the compute components 110 can implement the deep preprocessing network 120, the deep postprocessing network 130, and/or the rendering engine 140. In other examples, the compute components 110 can also implement one or more other processing engines or networks.

In some examples, the operations for the deep preprocessing network 120, the deep postprocessing network 130, and the rendering engine 140 can be implemented by one or more of the compute components 110. In one illustrative example, the deep preprocessing network 120 and/or the deep postprocessing network 130 (and associated operations) can be implemented by the CPU 112, the DSP 116, and/or the ISP 118, and the rendering engine 140 (and associated operations) can be implemented by the GPU 114. In some cases, the compute components 110 can include other electronic circuits or hardware, computer software, firmware, or any combination thereof, to perform any of the various operations described herein.

In some cases, the compute components 110 can receive data (e.g., image data, etc.) captured by the image sensor 102 and/or the image sensor 104, and perform compression and/or decompression operations on the data, steganography and steganalysis operations, generative and adversarial operations, etc. For example, the compute components 110 can receive image data (e.g., one or more frames, etc.) captured by the image sensor 102, encode the image data using stenography, decode the image data using steganalysis, compress the image data, decompress the image data, generate higher entropy versions of the image data, perform classification operations on the generated image data, etc., as described herein.

The compute components 110 can implement the preprocessing network 120 to generate a lower entropy image and compress the lower entropy image. For example, the deep preprocessing network 120 can be used to reduce the entropy of an input image or frame by manipulating the RGB channels in the image or frame, and creating a lower entropy image or frame based on the input image or frame. An image or frame can be a red-green-blue (RGB) image or frame having red, green, and blue color components per pixel; a luma, chroma-red, chroma-blue (YCbCr) image or frame having a luma component and two chroma (color) components (chroma-red and chroma-blue) per pixel; or any other suitable type of color or monochrome picture.

In some examples, the input image can include a cover image and a target (or source) image. Moreover, the steganography encoder 122 in the preprocessing network 120 can combine the cover image and the target image to generate a steganography image that includes the target image embedded in the cover image. The steganalysis decoder 124 in the preprocessing network 120 can receive the steganography image, extract or recover the target image from the steganography image, and generate a lower entropy version of the target image. The lower entropy target image can have some image content information removed by the steganalysis decoder 124 to reduce the size of the image. In some examples, the image content information removed from the target image can include style information. The style information can include information about the appearance or visual style of the image such as, for example and without limitation, texture, color, edge, resolution, temperature, image background, dynamic range, details, illumination, etc.

In some examples, the steganography encoder 122 can implement a deep neural network, such as a convolutional neural network (CNN), which can embed the target image into the cover image to generate the steganography image. The target image can have a higher entropy than the target image generated by the steganalysis decoder 124. In some examples, the steganalysis decoder 124 can implement a deep neural network, such as a CNN, which can extract or recover the embedded target image from the steganography image generated by the steganography encoder 122, and generate a version of the embedded target image having a lower entropy.

In some examples, the steganalysis decoder 124 can reduce the entropy of the embedded target or source image by manipulating RGB channels in the image and removing style information from the image. In some cases, the steganography encoder 122 can be trained with the steganalysis decoder 124. In some cases, after a first stage of training, only the steganography encoder 122 is used. In a second stage, the steganalysis decoder 124 is trained along with the steganalysis decoder 124.

The compute components 110 can also implement the compression encoder 126 to compress the lower entropy target image generated by the steganalysis decoder 124 to further reduce its size. To compress the lower entropy target image, the compression encoder 126 can implement a compression algorithm, such as JPEG or DCT. The compression algorithm can match the format of a decompression algorithm used by a decompression decoder 132 in the deep postprocessing network 130 to decompress the lower entropy target image from the deep preprocessing network 120.

In some examples, the compute components 110 can implement the deep postprocessing system 130 to decompress the lower entropy target image generated by the deep preprocessing network 120 and generate a higher entropy target image based on the decompressed lower entropy target image. The deep postprocessing system 130 can implement the decompression decoder 132 to decompress the lower entropy image, and a transfer network 134 to generate the higher entropy target image. In some examples, the transfer network 134 can generate the higher entropy target image by transferring style information back into the lower entropy target image. For example, the transfer network 134 can learn the style information from sample or training images in one domain, and transfer the style information to the lower entropy target image. To illustrate, if the style information removed by the steganalysis decoder 124 from the target image includes color information pertaining to a blue sky in the target image, the transfer network 134 can learn such color information from other images, such as natural images, and add such learned color information back into the lower entropy target image to produce the higher entropy target image with the added style information. In some examples, the higher entropy target image can produce a higher image quality than the lower entropy target image.

In some examples, the transfer network 134 can be a deep steganalysis transfer network implementing one or more neural networks. In some cases, the transfer network 134 can include the generator 136 and the discriminator 138. In some cases, the generator 136 can be a deep steganalysis transfer decoder and the discriminator 138 can be a deep adversarial network. Moreover, the generator 136 can implement a generative adversarial network (GAN), which can take as input the lower entropy target image from the deep preprocessing network 120 and generate the higher entropy target image as its output. In some examples, the generator 136 can perform as a style transfer network that takes the lower entropy target image and generates the higher entropy target image by transferring learned style information back into the target image as previously noted.

For example, the generator 136 can learn a style of the target image from an image dataset used to train the generator 136, such as a dataset of natural images, animal images, landscape images, object images, etc. In some cases, the generator 136 can transfer style information from a higher image quality domain to a lower image quality domain of the lower entropy target image. In some examples, the generator 136 can learn style information for the target image by interpolating across adjacent image frames. In some cases, the generator 136 can increase the entropy of the decompressed lower entropy target image by adding back style information and as a result producing a higher entropy target image which, in some examples, can be comparable to the original target image embedded in the cover image. The generator 136 can be trained to produce higher entropy target images that can pass a discrimination or classification test by the discriminator 138. Thus, the generator 136 can aim to increase the entropy of the target image and produce a higher entropy target image that can pass the discrimination or classification test by the discriminator 138.

In some examples, the generator 136 can be trained on a dataset of higher quality or higher entropy RGB images that have similar statistical properties as the original target image processed by the deep preprocessing network 120, and can learn style information from the dataset without interacting with the steganography encoder 122 in the preprocessing network 120. As a result, the deep preprocessing network 120 does not need to transmit the style information of the target image to the postprocessing network 130 for the generator 136 to produce the higher entropy target image. This allows the target image transmitted by the preprocessing network 120 to have a reduced size with a lower latency and bandwidth requirements.

The discriminator 138 can be part of the generator 136 or can be a separate neural network. The discriminator 138 can be trained to classify/label images generated by the generator 136 as real or fake and/or distinguish between images generated by the generator 136 and real or fake images. Thus, the goal of the discriminator 138 can be to recognize images generated by the generator 136 as real or fake, and the goal of the generator 136 can be to generate higher entropy images that fool or trick the discriminator 138 into recognizing the generated higher entropy images as authentic or real.

In some examples, to classify or label an image generated by the generator 136, the discriminator 138 can extract features from the image and analyze the extracted features to identify the image as real or fake. For example, in some cases, to classify the images produced by the generator 136, the discriminator 138 can extract features from the images and compare the features with those of other images (real and/or fake) used to train the discriminator 138 in order to identify a match or mismatch between the features extracted from the generated images and the features from the other images used to train the discriminator 138 and determine whether the generated images appear real or fake. In some cases, in an inference phase, the discriminator 138 can be removed or unused after all the networks are trained.

In some cases, the discriminator 138 can downsample (e.g., by average pooling or any other mechanism) the generated image and extract features from the downsampled image. However, in other cases, the discriminator 138 can extract the features from the generated image without downsampling the generated image. In some examples, the discriminator 138 can apply a loss function to the generated image and/or a feature map associated with the generated image and output a result of the loss function. In some examples, the loss function can be a least squares loss function.

In some examples, the result from the loss function can be a binary or probabilities output such as [true, false] or [0, 1]. Such output can, in some cases, provide a classification or discrimination decision. For example, in some cases, the output can recognize or classify the generated image from the generator 136 as being real or fake.

In some cases, the compute components 110 can also implement the rendering engine 140. The rendering engine 140 can perform operations for rendering content, such as images, videos, text, etc., for display on a display device. The display device can be part of, or implemented by, the image processing system 100, or can be a separate device such as a standalone display device or a display device implemented by a separate computing device. The display device can include, for example, a screen, a television, a computer display, a projector, a head-mounted display (DMD), and/or any other type of display device.

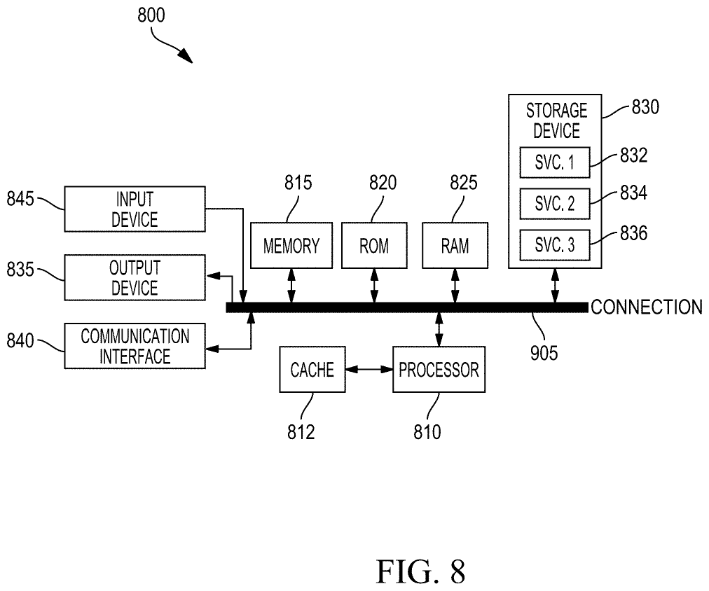

While the image processing system 100 is shown to include certain components, one of ordinary skill will appreciate that the image processing system 100 can include more or fewer components than those shown in FIG. 1. For example, the image processing system 100 can include, in some instances, one or more memory devices (e.g., RAM, ROM, cache, and/or the like), one or more networking interfaces (e.g., wired and/or wireless communications interfaces and the like), one or more display devices, and/or other hardware or processing devices that are not shown in FIG. 1. An illustrative example of a computing device and hardware components that can be implemented with the image processing system 100 is described below with respect to FIG. 8.

FIG. 2 illustrates a block diagram of an example training scheme 200 for training the deep preprocessing network 120 and the deep postprocessing network 130. In this example, the training scheme 260 considers style information of an image (e.g., the target image) as image content information that is available to a receiver of the image and hence does not need to be included in the image when the image is sent to the receiver. Therefore, the entropy and size of the image sent to the receiver can be reduced. In some examples, the entropy of the image can be reduced by Shannon's source coding theorem (or noiseless coding theorem), and the receiver of the image can use or need fewer bits to encode the remaining information associated with the image.

In this example, the input 202 to the deep preprocessing network 120 can include a target image, denoted by X, to be transmitted to the deep processing network 130. The target image X in the input 202 can include style information, which is denoted here by S, and the remaining information, which is denoted here by T. Accordingly, the target image X from the input 202 can be represented by X=(T,S) and given the target image X (e.g., input 202), the cost function or entropy H(X) can be expressed as: H(X)=H(T,S)=H(T)+H(S|T)≥H(T).

In some examples, the deep preprocessing network 120 and the deep postprocessing network 130 can be trained simultaneously or together to achieve min H(T) and min ∥X−X′∥₂ where X′ is the decompressed target image after postprocessing of deep postprocessing network. Thus, the deep preprocessing network 120 can be trained to identify the smallest amount of information (e.g., min H(T)) associated with the target image X that can be used to recover the original target image Xin the input 202, and/or minimize the amount of information that can be transmitted to the deep postprocessing network 130 to allow the deep postprocessing network 130 to recover the original target image X independently without the deep preprocessing network 120 (e.g., without using or interacting with the deep processing network 120). Stated otherwise, the deep preprocessing network 120 can be trained to maximize the amount of information that can be recovered by the deep postprocessing network 130 and minimize the entropy of the output 204 from the deep preprocessing network 220. The output 204 of the deep preprocessing network 120 can be the minimized information T that can be used to recover the original target image X without the style information S.

The deep postprocessing network 130 can be trained to recover the original target image X with minimal distortion using the minimal information (min H(T)), as expressed by min ∥X−X′∥₂. The input 212 to the deep postprocessing network 130 can include the remaining information T, which the deep postprocessing network 130 can use to generate an output 214. The output 214 can be the recovered target image X generated from the input 212. For example, the output 214 can be a higher entropy target image generated from lower entropy image data in the input 212.

In some examples, the input 212 to the deep postprocessing network 130 can also include added noise, such as a random vector for example. The noise can be added to train the deep postprocessing network 130 to improve its performance by gradually decreasing the noise variance as the deep postprocessing network 130 learns.

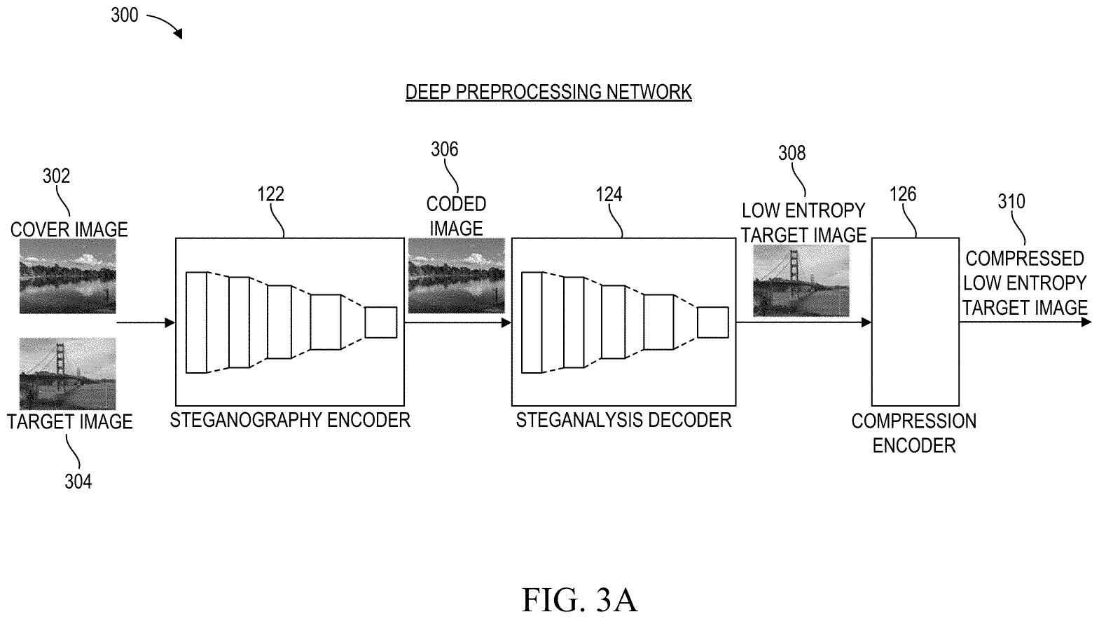

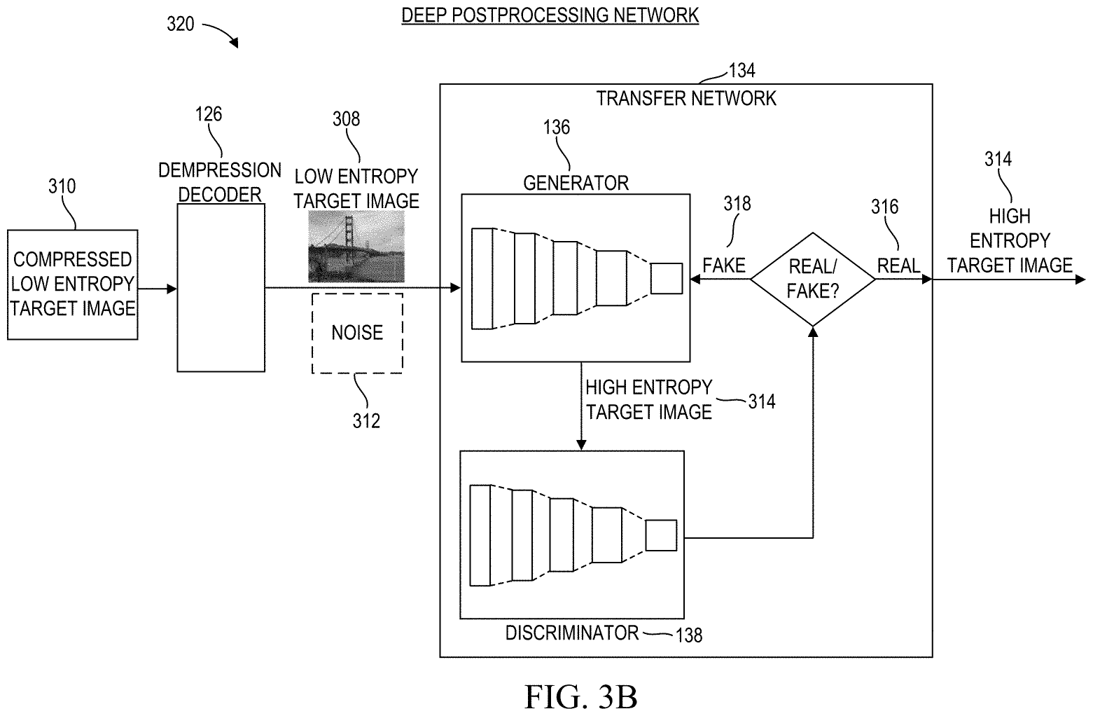

FIG. 3A illustrates an example system flow 300 implemented by the deep preprocessing network 120 for high efficiency compression of image data. In this example, the steganography encoder 122 in the deep preprocessing network 120 receives as input a cover image 302 and a target image 304. In some examples, the target image 304 can be an image with a high entropy and/or quality, and the cover image 302 can be any image, such as a random image, used as a cover image.

The steganography encoder 122 can implement a steganography algorithm to combine the cover image 302 and the target image 304 and produce a coded image 306 (e.g., a steganography image or steganography container image) containing the cover image 302 and the target image 304 embedded into the cover image 302. In some examples, the steganography encoder 122 can implement one or more neural networks, such as one or more CNNs, to embed the target image 304 into the cover image 302.

In some examples, the steganography encoder 122 can embed the target image 304 into the cover image 302 with minimal or limited distortion to the cover image 302. The goal of the steganography encoder 122 can be to create the coded image 306 such that the target image 304 in the coded image 306 is invisible or imperceptible to a user, and the difference between the coded image 306 and the cover image 302 is visually imperceptible. In some cases, the steganography encoder 122 can embed the target image 304 into the cover image 302 while preserving spatial information of the target image 304.

The steganalysis decoder 124 in the deep preprocessing network 120 can receive the coded image 306 as input, extract the target image 304 from the coded image 306, and generate a lower entropy target image 308. The lower entropy target image 308 can be a version of the target image 304 having a lower entropy, which can be represented by a fewer number of bits than the target image 304 (and can have a smaller data size). For example, the lower entropy target image 308 can be a version of the target image 304 having less image content information than the target image 304. The image content information can be style information removed by the steganalysis decoder 124 from the target image 304. In some examples, the steganalysis decoder 124 can generate the lower entropy target image 308 by removing style information from the target image 304 recovered from the coded image 306.

In some examples, the cover image 302 in the coded image 306 can be used as a tuning parameter to train the steganography encoder 122 to embed the target image 304 with minimal or limited distortion of the cover image 302 and/or to train the steganalysis decoder 124 to detect and extract the target image 304 from the coded image 306. Moreover, in some cases, the steganalysis decoder 124 can recover the target image 304 from the coded image 306 by calculating a difference between the coded image 306 and the cover image 302. The difference between the coded image 306 and the cover image 302 can correspond to or represent the target image 304. In some examples, the steganalysis decoder 124 can apply an inverse function such that, given the cover image 302 and the coded image 306, outputs the target image 304.

In some examples, the steganalysis decoder 124 can include one or more neural networks, such as a CNN. The one or more neural networks can implement a steganalysis algorithm to detect the target image 304 in the coded image 306, recover or extract the target image 304 from the coded image 306, and generate the lower entropy target image 308.

The compression encoder 126 can receive the lower entropy target image 308 generated by the steganalysis decoder 124 and compress the lower entropy target image 308 to generate a compressed lower entropy target image 310. The compressed lower entropy target image 310 can have a smaller data size than both the lower entropy target image 308 and the original target image 304. The compression encoder 126 can implement any compression algorithm, such as DCT or JPEG, to generate the compressed lower entropy target image 310.

Once the compression encoder 126 has generated the compressed lower entropy target image 310, the deep preprocessing network 120 can transmit the compressed lower entropy target image 310 to the deep postprocessing network 130 for processing as further described herein. The compressed lower entropy target image 310 can have a reduced data size which can consequently reduce the latency and bandwidth requirements of the compressed lower entropy target image 310 when transmitted to the deep postprocessing network 130 over a communication channel, such as a network.

FIG. 3B illustrates an example system flow 320 implemented by the deep postprocessing network 130 for high efficiency decompression of image data. In this example, the decompression decoder 132 in the deep postprocessing network 130 receives as input the compressed lower entropy target image 310 generated by the deep preprocessing network 120.

The decompression decoder 132 can implement a decompression algorithm to decompress the compressed lower entropy target image 310 from the deep preprocessing network 120. The decompression decoder 132 can implement any decompression algorithm available now or developed in the future. Moreover, the decompression decoder 132 can implement a decompression algorithm that matches a format used by the compression algorithm implemented by the compression encoder 126 to generate the compressed lower entropy target image 310.

After decompressing the compressed lower entropy target image 310, the decompression decoder 132 can output the lower entropy target image 308, which can be the decompressed image generated from the compressed lower entropy target image 310. The lower entropy target image 308 from the decompression decoder 132 can then be fed to the transfer network 134 for processing.

At the transfer network 134, the generator 136 can receive the lower entropy target image 308 and generate a higher entropy target image 314. To generate the higher entropy target image 314, the generator 136 can increase the entropy of the lower entropy target image 308 by adding image content information to the lower entropy target image 308. For example, the generator 136 can learn style information for the target image and add the style information to the lower entropy target image 308 to generate the higher entropy target image 314 with the added style information. In some cases, the generator 136 can perform a style transfer where the generator 136 learns the style of a set of images in a desired or selected domain, and adapts the lower entropy target image 308 to include style information learned from the set of images and/or appear as if drawn or created from the desired or selected domain.

The generator 136 can aim to generate the higher entropy target image 314 to have a high similarity to the original target image 304, have a high quality similar to the original target image 304, and/or visually resemble the original target image 304. To this end, the generator 136 can implement a cost function that penalizes poor results (e.g., output images with lower similarity, lower quality, etc.) or mismatches between the higher entropy target image 314 and the original target image 304, and can optimize the coefficients of the cost function as it learns and produces better results (e.g., output images with higher similarity, higher quality, etc.) or generated images that better match the original target image 304. The generator 136 can also interact with the discriminator 138 to enhance the learning process, as further described below.

In some examples, the generator 136 can be trained using a set of images having certain style information. For example, the generator 136 can be trained using a set of images having a style with a threshold similarity to the style of the original target image 304. In some training scenarios, the training input to the generator 136 can include a noise image 312 (or noise vector), which can be used to train the generator 136 to generate higher entropy images that are higher quality and/or appear realistic. The noise image 312 can add noise to the training dataset, and can help the generator 136 learn (and optimize) to transfer style information from a domain of training images to the lower entropy target image 308. However, in some example inference or testing stages, the input to the generator 136 may not include the noise image 312, and the generator 136 can generate the higher entropy target image 314 without the noise image 312.

The generator 136 can provide the higher entropy target image 314 to the discriminator 138, which can analyze the higher entropy target image 314 generated by the generator 136 to classify it as real or fake. The output from the discriminator 138 can be a classification which can indicate or label the higher entropy target image 314 as real 316 or fake 318. In some examples, the discriminator 138 can be trained to detect generated images that match or resemble the original target image 304. The discriminator 138 can implement a cost function that penalizes poor results. In some examples, the noise image 312 can be added to the target domain dataset used to train the discriminator 138 and the noise variance can be gradually reduced as the generator 136 learns and produces better (e.g., more realistic, higher quality, or better matching) results.

If the discriminator 138 classifies the recovered secret image 312 as real 316, the deep postprocessing network 130 can use the higher entropy target image 314 as the output from the deep postprocessing network 130. Thus, the output from the deep postprocessing network 130 can be a higher entropy target image that is recognized by the discriminator 138 as real and that matches or resembles an appearance and/or quality of the original target image 304.

If the discriminator 138 classifies the higher entropy target image 314 as fake 318, the generator 136 can generate a new higher entropy target image and continue to do so until it generates a higher entropy target image that is recognized by the discriminator 138 as real 316.

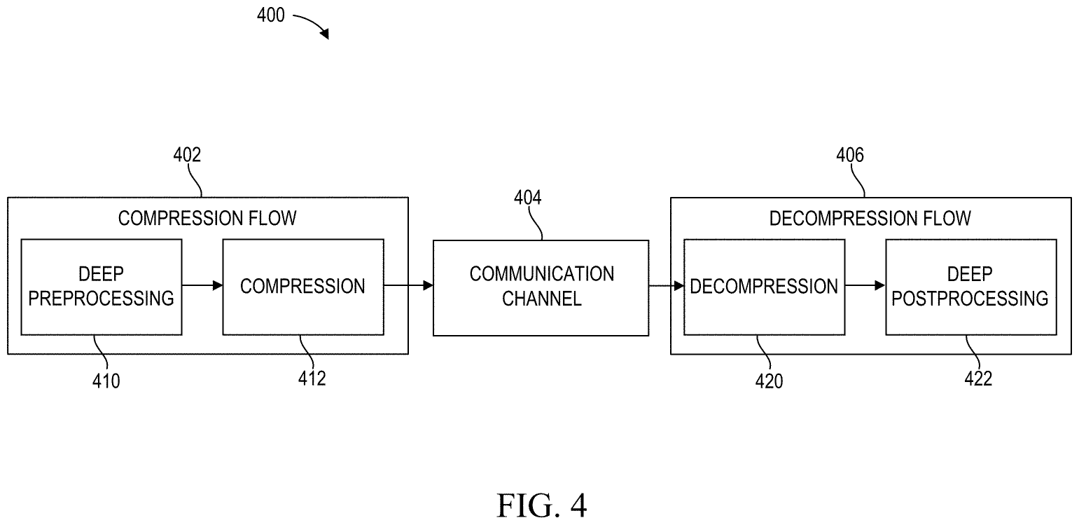

FIG. 4 illustrates an example high efficiency compression and decompression flow 400. The example high efficiency compression and decompression flow 400 can include a compression process 402 and a decompression process 406.

At block 410 of the compression process 402, the deep preprocessing network 120 can perform deep preprocessing on an input cover image and an input target image. The deep preprocessing can be performed by the steganography encoder 122 and the steganalysis decoder 124, as previously described. The steganography encoder 122 can implement a steganography algorithm to embed the target image into the cover image in a manner that is invisible or visually imperceptible to a user and without (or with limited) visual distortion to the cover image. The steganography encoder 122 can output a steganography image (or steganography container image) containing the cover image with the target image embedded into the cover image. The steganalysis decoder 124 can receive the steganography image, detect the target image embedded in the cover image and extract or recover the target image using a steganalysis algorithm. The steganalysis decoder 124 can then reduce the entropy of the target image recovered or extracted, which results in a lower entropy target image that can be represented by a fewer number of bits (and can have a smaller data size) than the original target image. In some examples, the steganalysis decoder 124 can reduce the entropy of the target image by removing image content information from the target image, such as style information.

At block 412 of the compression process 402, the compression encoder 126 of the deep preprocessing network 120 can compress the lower entropy target image from the steganalysis decoder 124. The compression encoder 126 can implement any compression algorithm to compress the lower entropy target image, such as JPEG or DCT for example.

The output from the compression process 402 can by a compressed lower entropy target image. The compressed lower entropy target image can be transmitted to the deep postprocessing network 130 to perform the decompression process 406. The compressed lower entropy target image can be transmitted to the deep postprocessing network 130 over a communication channel 404.

The communication channel 404 can include any wired and/or wireless communication channel. For example, the communication channel 404 can include one or more networks such as, for example, a private network (e.g., local area network, virtual private network, on-premises datacenter, wireless local area network, etc.), a public network (e.g., wide area network, public cloud, public service provider network, etc.), and/or a hybrid network (e.g., hybrid cloud, combination of private and public networks, etc.). The data size of the compressed lower entropy target image can be smaller than the data size of the original target image as the compressed lower entropy target image has a reduced entropy and is compressed. Accordingly, the compressed lower entropy target image can be transmitted over the communication channel 404 at a lower transmission rate, a lower latency and a lower bandwidth, which can not only increase the speed of delivery but also limit or prevent any lag in the data received at the deep postprocessing network 130.

At block 420 of the decompression process 406, the decompression decoder 132 of the deep postprocessing network 130 can decompress the compressed lower entropy target image using a decompression algorithm. The decompression algorithm can match the format associated with the compression algorithm implemented by the compression encoder 126 at the deep preprocessing network 120.

At block 422 of the decompression process 406, the generator 136 in the transfer network 134 of the deep postprocessing network 130 can use the lower entropy target image to generate a higher entropy target image by adding style information back into the lower entropy target image. The generator 136 can learn the style information from a dataset of training images, and can transfer the learned style information to the lower entropy target image to produce the higher entropy target image. In some examples, by adding the style information to the lower entropy target image and increasing the entropy of the lower entropy target image, the generator 136 can produce a target image with a higher quality and/or a higher amount of details (e.g., style). In some cases, the higher entropy target image can have a comparable or similar image quality and/or visual appearance as the original target image.

In some cases, at block 422 of the decompression process 406, the discriminator 138 in the transfer network 134 can obtain the higher entropy target image generated by the generator 136 and analyze the higher entropy target image to determine whether the higher entropy target image appears real or fake. In some examples, the discriminator 138 can determine that the higher entropy target image is real if it is determined to have a threshold similarity to the original target image and/or one or more real images from a dataset.

If the discriminator 138 determines that the higher entropy target image appears real or passes a real/fake test performed by the discriminator 138, the higher entropy target image can be provided as the final output of the decompression process 406. On the other hand, if the discriminator 138 determines that the higher entropy target image does not appear real or does not pass a real/fake test performed by the discriminator 138, the discriminator 138 can signal or trigger the generator 136 to generate another higher entropy target image. When the generator 136 generates another higher entropy target image, the discriminator 138 can again analyze the generated image to determine whether the generated image appears real or fake. This process can continue until the generator 136 generates a higher entropy target image that passes the real/fake test of the discriminator 138.

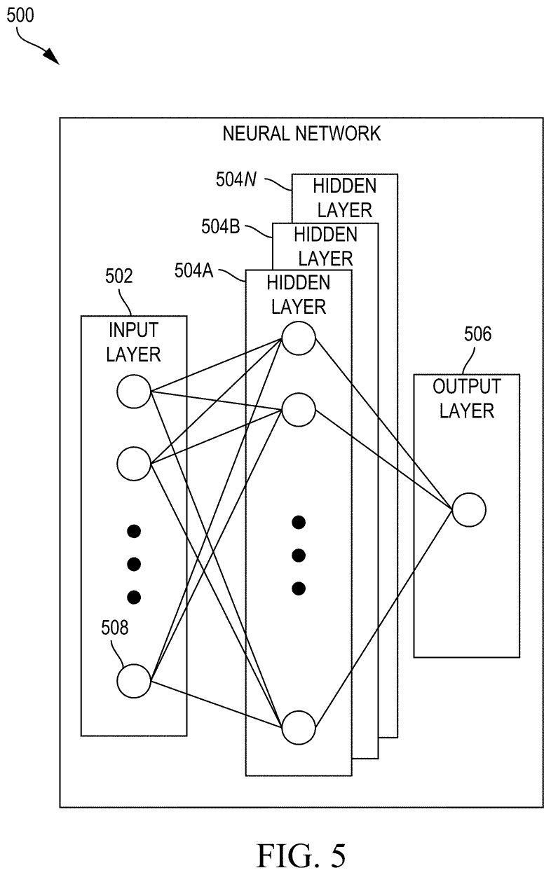

FIG. 5 illustrates an example configuration of a neural network 500 that can be implemented by one or more components of the deep preprocessing network 120 and/or the deep postprocessing network 130, such as the steganography encoder 122, the steganalysis decoder 124, the compression encoder 126, the decompression decoder 132, the generator 136, and/or the discriminator 138. For example, the neural network 500 can be implemented by the steganography encoder 122 to generate a steganography image including a cover image with a target image embedded into the cover image, the steganalysis decoder 124 to recover the target image from the steganography image and generate a lower entropy target having minimized entropy information (min H(T)), the generator 136 to learn style information (with or without interacting with the steganography encoder 122) and transfer learned style information to the lower entropy target image from the deep preprocessing network 120 to generate a higher entropy target image, and/or the discriminator 138 to classify or label the higher entropy target image from the generator 136 as real or fake.

In this example, the neural network 500 includes an input layer 502, which includes input data. In one illustrative example, the input data at input layer 502 can include image data, such as a target image and a cover image, a steganography image, a lower entropy target image, a noise image, a higher entropy target image, a set of training images, etc.

The neural network 500 further includes multiple hidden layers 504A, 504B, through 504N (collectively “504” hereinafter). The neural network 500 can include “N” number of hidden layers (504), where “N” is an integer greater or equal to one. The number of hidden layers can include as many layers as needed for the given application.

The neural network 500 further includes an output layer 506 that provides an output resulting from the processing performed by the hidden layers 504. For example, the output layer 506 can provide an encoded or decoded image (e.g., a steganography image, a lower entropy target image, a higher entropy target image, a compressed image, a decompressed image, etc.), a discrimination result (e.g., a classification or label), a feature extraction result, etc.

The neural network 500 is a multi-layer neural network of interconnected nodes. Each node can represent a piece of information. Information associated with the nodes is shared among the different layers (502, 504, 506) and each layer retains information as it is processed. In some examples, the neural network 500 can be a feed-forward network, in which case there are no feedback connections where outputs of the network are fed back into itself. In other examples cases, the neural network 500 can be a recurrent neural network, which can have loops that allow information to be carried across nodes while reading in input.

Information can be exchanged between nodes in the layers (502, 504, 506) through node-to-node interconnections between the layers (502, 504, 506). Nodes of the input layer 502 can activate a set of nodes in the first hidden layer 504A. For example, as shown, each of the input nodes of the input layer 502 is connected to each of the nodes of the first hidden layer 504A. The nodes of the hidden layers 504 can transform the information of each input node by applying activation functions to the information. The information derived from the transformation can then be passed to, and activate, the nodes of the next hidden layer 504B, which can perform their own designated functions. Example functions include, without limitation, convolutional, up-sampling, down-sampling, data transformation, and/or any other suitable functions. The output of the hidden layer 504B can then activate nodes of the next hidden layer, and so on. The output of the last hidden layer 504N can activate one or more nodes of the output layer 506, which can then provide an output. In some cases, while nodes (e.g., 508) in the neural network 500 are shown as having multiple output lines, a node has a single output and all lines shown as being output from a node represent the same output value.

In some cases, each node or interconnection between nodes can have a weight that is a set of parameters derived from a training of the neural network 500. For example, an interconnection between nodes can represent a piece of information learned about the interconnected nodes. The interconnection can have a numeric weight that can be tuned (e.g., based on a training dataset), allowing the neural network 500 to be adaptive to inputs and able to learn as more and more data is processed.

In some cases, the neural network 500 can be pre-trained to process the data in the input layer 502 using the different hidden layers 504 in order to provide the output through the output layer 506. The neural network 500 can be further trained as more input data, such as image data, is received. In some cases, the neural network 500 can be trained using unsupervised learning. In other cases, the neural network 500 can be trained using supervised and/or reinforcement training. As the neural network 500 is trained, the neural network 500 can adjust the weights and/or biases of the nodes to optimize its performance.

In some cases, the neural network 500 can adjust the weights of the nodes using a training process such as backpropagation. Backpropagation can include a forward pass, a loss function, a backward pass, and a weight update. The forward pass, loss function, backward pass, and parameter update is performed for one training iteration. The process can be repeated for a certain number of iterations for each set of training data (e.g., image data) until the weights of the layers 502, 504, 506 in the neural network 500 are accurately tuned.

To illustrate, in an example where neural network 500 is configured to learn style information for a target image, the forward pass can include passing image data samples through the neural network 500. The weights may be initially randomized before the neural network 500 is trained. For a first training iteration for the neural network 500, the output may include values that do not give preference to any particular feature, as the weights have not yet been calibrated. With the initial weights, the neural network 500 may be unable to detect or learn some features or details and thus may yield poor results for some features or details. A loss function can be used to analyze error in the output. Any suitable loss function definition can be used. One example of a loss function includes a mean squared error (MSE). The MSE is defined as Eₜₒₜₐₗ=Σ½(target−output)², which calculates the sum of one-half times the actual answer minus the predicted (output) answer squared. The loss can be set to be equal to the value of Eₜₒₜₐₗ.

The loss (or error) may be high for the first training image data samples since the actual values may be much different than the predicted output. The goal of training can be to minimize the amount of loss for the predicted output. In some cases, the neural network 500 can perform a backward pass by determining which inputs (weights) most contributed to the loss of the neural network 500, and can adjust the weights so the loss decreases and is eventually minimized.

A derivative of the loss with respect to the weights (denoted as dL/dW, where W are the weights at a particular layer) can be computed to determine the weights that most contributed to the loss of the neural network 500. After the derivative is computed, a weight update can be performed by updating all the weights of the filters. For example, the weights can be updated so they change in the opposite direction of the gradient. The weight update can be denoted as w=wᵢ−ηdL/dW, where w denotes a weight, wᵢ denotes the initial weight, and η denotes a learning rate. The learning rate can be set to any suitable value, with a high learning rate including larger weight updates and a lower value indicating smaller weight updates.

The neural network 500 can include any suitable neural network. One example includes a convolutional neural network (CNN), which includes an input layer and an output layer, with multiple hidden layers between the input and output layers. The hidden layers of a CNN include a series of convolutional/deconvolutional, nonlinear, pooling, fully connected normalization, and/or any other layers. The neural network 500 can include any other deep network, such as an autoencoder (e.g., a variable autoencoder, etc.), a deep belief nets (DBNs), a recurrent neural networks (RNNs), a residual network (ResNet), a GAN, a steganography encoder network, a steganalysis decoder network, among others.

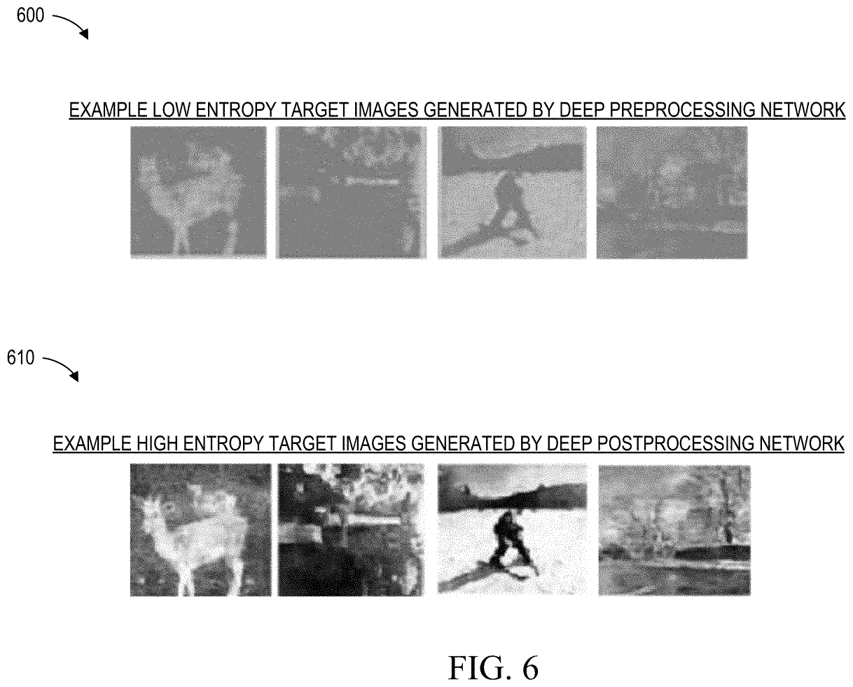

FIG. 6 illustrates example lower entropy target images 600 generated by the deep preprocessing network 120 and example higher entropy target images 610 generated by the deep postprocessing network 130 based on the example lower entropy target images 600. As illustrated, the lower entropy target images 600 appear to have less image details than the higher entropy target images 610 and visually appear to have a lower quality. This is because the deep preprocessing network 120 has removed style information from target images used to generate the lower entropy target images 600. The removal of the style information has consequently reduced the entropy of the target images, resulting in the lower entropy target images 600.

The deep postprocessing network 130 can obtain the lower entropy target images 600 and add style information back into the lower entropy target images 600 to generate the higher entropy target images 610. The deep postprocessing network 130 can learn the style information for the target images and transfer the learned style information to the lower entropy target images 600 to produce the higher entropy target images 610. In some examples, the image quality and/or entropy of the higher entropy target images 610 can be similar and/or comparable to that of the original target images.

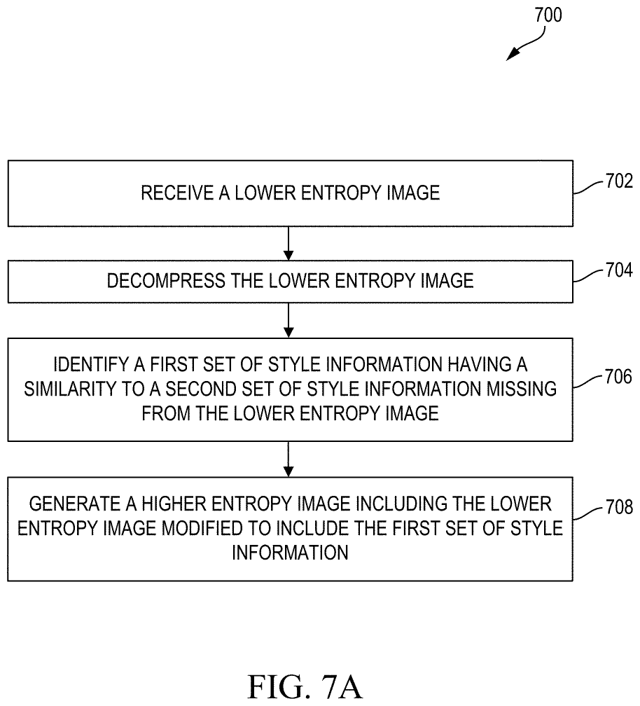

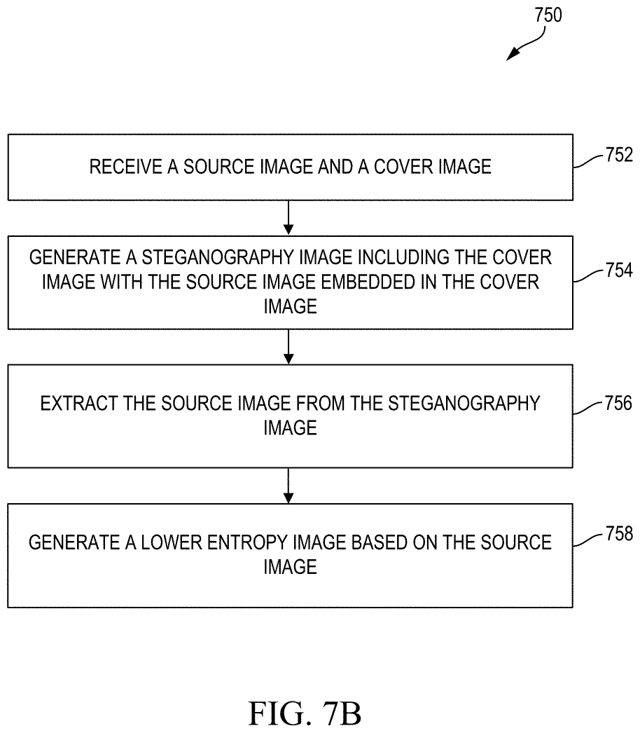

Having described example systems and concepts, the disclosure now turns to the example methods 700 and 750 for high efficiency compression and decompression, as shown in FIGS. 7A and 7B. The steps outlined in the methods 700 and 750 are examples and can be implemented in any combination thereof, including combinations that exclude, add, or modify certain steps.

FIG. 7A illustrates an example method 700 for high efficiency decompression. At block 702, the method 700 can include receiving (e.g., via deep postprocessing network 130) a lower entropy image (e.g., 310). The lower entropy image can be a lower entropy version of a source image (e.g., target image 304). The lower entropy image can have a reduced entropy relative to the source image and a compressed state relative to the source image. For example, the lower entropy image can be a version of the source image that when generated, is represented be a few number of bits, and is subsequently compressed to further reduce its data size.

At block 704, the method 700 can include decompressing (e.g., via decompression decoder 126) the lower entropy image. In some examples, the lower entropy image can be decompressed using any decompression algorithm such as, for example, DCT or JPEG. In some cases, the lower entropy image can be decompressed using a decompression algorithm that uses a format that matches the format of a compression algorithm used to compress the lower entropy image.

At block 706, the method 700 can include identifying (e.g., by generator 136 of the deep postprocessing network 130) a first set of style information having a similarity to a second set of style information missing from the lower entropy image. In some examples, the second set of style information can include style information included in the source image and removed from the lower entropy image. In some examples, the first set of style information and/or the second set of style information can include color information, texture information, image temperature information, background image data, illumination information, information about one or more image edges, and/or one or more visual image details.

In some cases, the first set of style information can be identified without accessing or referencing the second set of style information included in the source image and removed from the lower entropy image. In some examples, identifying the first set of style information can include learning the first set of style information from one or more different images. In some cases, the first set of style information can be learned without reference to the source image and/or without interacting with an encoder (e.g., 122) that coded the source image and/or the lower entropy image

In some cases, the first set of style information is learned by analyzing a dataset of images having one or more statistical properties selected based on one or more properties of the lower entropy image. For example, the first set of style information can be learned from images that have a style with a threshold similarity to a style of the lower entropy image and/or the source image associated with the lower entropy image.

At block 708, the method 700 can include generating (e.g., by the generator 136 of the deep postprocessing network 130) a higher entropy image (e.g., 314) including the lower entropy image modified to include the first set of style information. In some examples, generating the higher entropy image can include learning the first set of style information from one or more different images and transferring the first set of style information learned to the lower entropy image. In some cases, generating the higher entropy image can include increasing an entropy of the lower entropy image by adding the first set of style information to the lower entropy image.

In some aspects, the method 700 can include classifying (e.g., by discriminator 138 of the deep postprocessing network 130) the higher entropy image as a real image or a fake image. For example, a discriminator (e.g., discriminator 138) can classify the higher entropy image generated by a generator (e.g., generator 136 of the deep postprocessing network 130) as a real image if it is determined to have a threshold quality and/or a threshold similarity to the source image and/or one or more real images, and/or if the discriminator determines that the higher entropy image generated by the generator is indeed a higher entropy image. On the other hand, the discriminator can classify the higher entropy image generated by the generator as a fake image if it determines that the higher entropy image generated by the generator does not have a threshold quality and/or a threshold similarity to the source image and/or one or more real images, and/or if the discriminator 138 considers the higher entropy image generated by the generator to actually be a lower entropy image.

To illustrate, in some examples, the discriminator (e.g., discriminator 138) can be pre-trained separately (e.g., separate from the generator 138) to classify/label higher entropy images having the desired or correct style information as real or true, and any images that fall outside of this category (e.g., images that are not higher entropy images having the desired or correct style information) as fake or false. In some examples, the generator (e.g., generator 136) can then be trained to generate higher entropy images with desired or correct style information by interacting with the pre-trained discriminator. The generator can then classify the output from the generator (e.g., the higher entropy image generated by the generator) as real or fake depending on whether the discriminator determines that the output from the generator (e.g., the higher entropy image) is indeed a higher entropy image with the desired or correct style information or not.

Thus, if the discriminator determines that the higher entropy image generated at block 708 passes the discriminator's test for classifying the output from the generator as a higher entropy image having the desired or correct style information, the discriminator can classify the output higher entropy image from the generator as real. Alternatively, if the discriminator determines that the higher entropy image generated at block 708 does not pass the discriminator's test for classifying the output from the generator as a higher entropy image having the desired or correct style information, the discriminator can classify the output higher entropy image from the generator as fake.

In some aspects, the method 700 can include outputting the higher entropy image when the higher entropy image is classified as the real image. In other aspects, the method 700 can include when the higher entropy image is classified as a fake image, generating (e.g., by the generator 136) a new higher entropy image including the lower entropy image modified to include a third set of style information having a further similarity to the second set of style information missing from the lower entropy image, and classifying (e.g., by the discriminator 138) the new higher entropy image as the real image or the fake image.

FIG. 7B illustrates an example method 750 for high efficiency compression. At block 752, the method 750 can include receiving (e.g., by a steganography encoder 122 of a deep preprocessing network 120) a source image (e.g., target image 304) and a cover image (e.g., 302). The source image can be an image intended for transmission to a recipient device at a reduced latency and bandwidth. In some examples, the cover image can be a random image used as a cover or container image for a steganography image having the source image invisibly embedded therein.

At block 754, the method 750 can include generating (e.g., by the steganography encoder 122) a steganography image (e.g., 306) including the cover image with the source image embedded in the cover image. In some examples, the source image can be at least partly visually hidden within the cover image.

At block 756, the method 750 can include extracting (e.g., by a steganalysis decoder 124 of the deep preprocessing network 120) the source image from the steganography image. In some examples, the source image can be recovered from the steganography image using a steganalysis algorithm that identifies a difference between the steganography image and the cover image to identify the source image embedded in the cover image.

At block 758, the method 750 can include generating (e.g., by the steganalysis decoder 124) a lower entropy image based on the source image. The lower entropy image can be a version of the source image having a reduced entropy. For example, the lower entropy image can be a version of the source image represented by a fewer number of bits than the source image, and hence having a smaller data size.

In some examples, generating the lower entropy image can include removing style information from the source image extracted from the steganography image to reduce the entropy of the source image. In some examples, the lower entropy image can be generated by a steganalysis decoder using a steganalysis algorithm. In some cases, the style information can include color information, texture information, image temperature information, information about one or more image edges, background image data, illumination information, and/or one or more visual image details.

In some aspects, the method 750 can include compressing the lower entropy image after generating the lower entropy image, and sending the compressed lower entropy image (e.g., 310) to a deep postprocessing network (e.g., 130) that can decompress the lower entropy image and generate a higher entropy image from the lower entropy image by adding back style information to the lower entropy image.

In some cases, a deep preprocessing network 120 that generates the lower entropy image can be trained to use the style information and remaining information (e.g., T) of the source image to generate a reduced set of image data (e.g., min H(T) or output 204) that can be used with the style information to generate a higher entropy image (e.g., X′ or output 214, or 314). In some examples, the reduced set of image data can include at least part of the remaining information (e.g., min H(T) and/or min ∥X−X′∥₂).

In some examples, the methods 700 and 750 may be performed by one or more computing devices or apparatuses. In one illustrative example, the methods 700 and 750 can be performed by the image processing system 100 shown in FIG. 1 and/or one or more computing devices with the computing device architecture 800 shown in FIG. 8. In some cases, such a computing device or apparatus may include a processor, microprocessor, microcomputer, or other component of a device that is configured to carry out the steps of the methods 700 and/or 750. In some examples, such computing device or apparatus may include one or more sensors configured to collect sensor data. For example, the computing device can include a head-mounted display, a mobile device, a camera, a server, or other suitable device. In some examples, such computing device or apparatus may include a camera configured to capture one or more images or videos. In some cases, such computing device may include a display for displaying images and/or videos. In some examples, the one or more sensors and/or camera are separate from the computing device, in which case the computing device receives the sensor data. Such computing device may further include a network interface configured to communicate data.

The methods 700 and 750 are illustrated as logical flow diagrams, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the methods 700 and 750 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 illustrates an example computing device architecture 800 of an example computing device which can implement various techniques described herein. For example, the computing device architecture 800 can implement at least some portions of the image processing system 100 shown in FIG. 1, and perform high efficiency compression and/or decompression as described herein. The components of the computing device architecture 800 are shown in electrical communication with each other using a connection 805, such as a bus. The example computing device architecture 800 includes a processing unit (CPU or processor) 810 and a computing device connection 805 that couples various computing device components including the computing device memory 815, such as read only memory (ROM) 820 and random access memory (RAM) 825, to the processor 810.

The computing device architecture 800 can include a cache of high-speed memory connected directly with, in close proximity to, or integrated as part of the processor 810. The computing device architecture 800 can copy data from the memory 815 and/or the storage device 830 to the cache 812 for quick access by the processor 810. In this way, the cache can provide a performance boost that avoids processor 810 delays while waiting for data. These and other modules can control or be configured to control the processor 810 to perform various actions. Other computing device memory 815 may be available for use as well. The memory 815 can include multiple different types of memory with different performance characteristics. The processor 810 can include any general purpose processor and a hardware or software service, such as service 1 832, service 2 834, and service 3 836 stored in storage device 830, configured to control the processor 810 as well as a special-purpose processor where software instructions are incorporated into the processor design. The processor 810 may be a self-contained system, containing multiple cores or processors, a bus, memory controller, cache, etc. A multi-core processor may be symmetric or asymmetric.

To enable user interaction with the computing device architecture 800, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art, such as a display, projector, television, speaker device, etc. In some instances, multimodal computing devices can enable a user to provide multiple types of input to communicate with the computing device architecture 800. The communications interface 840 can generally govern and manage the user input and computing device output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof. The storage device 830 can include services 832, 834, 836 for controlling the processor 810. Other hardware or software modules are contemplated. The storage device 830 can be connected to the computing device connection 805. In one aspect, a hardware module that performs a particular function can include the software component stored in a computer-readable medium in connection with the necessary hardware components, such as the processor 810, connection 805, output device 835, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

What is claimed is:

1. A method comprising:
receiving, by a deep postprocessing network, a lower entropy image comprising a first version of a source image, the lower entropy image having a reduced entropy relative to the source image and a compressed state relative to the source image;
decompressing the lower entropy image;
identifying, by a generator network of the deep postprocessing network, a first set of style information having a similarity to a second set of style information missing from the lower entropy image, the second set of style information comprising style information included in the source image and removed from the lower entropy image; and
generating, by the generator network of the deep postprocessing network, a higher entropy image comprising the lower entropy image modified to include the first set of style information.

2. The method of claim 1, further comprising:
classifying, by a discriminator network of the deep postprocessing network, the higher entropy image as a real image or a fake image.

3. The method of claim 2, further comprising:
when the higher entropy image is classified as the real image, outputting the higher entropy image.

4. The method of claim 2, further comprising:
when the higher entropy image is classified as the fake image, generating, by the generator network, a new higher entropy image comprising the lower entropy image modified to include a third set of style information having a further similarity to the second set of style information missing from the lower entropy image; and
classifying, by the discriminator network, the new higher entropy image as the real image or the fake image.

5. The method of claim 1, wherein the style information comprises at least one of color information, texture information, image temperature information, information about one or more image edges, background image data, illumination information, and one or more visual image details.

6. The method of claim 1, wherein identifying the first set of style information having the similarity to the second set of style information comprises learning the first set of style information from one or more different images, and wherein generating the higher entropy image comprises adding the first set of style information learned from the one or more different images to the lower entropy image.

7. The method of claim 1, wherein identifying the first set of style information having the similarity to the second set of style information comprises learning the first set of style information from one or more different images, the first set of style information being learned without at least one of reference to the source image and interacting with an encoder that coded at least one of the source image and the lower entropy image.

8. The method of claim 1, wherein generating the higher entropy image comprises increasing an entropy of the lower entropy image by adding the first set of style information to the lower entropy image, wherein the first set of style information is learned by analyzing a dataset of images having one or more statistical properties selected based on one or more properties of the lower entropy image.

9. The method of claim 1, further comprising:
obtaining, by a steganography encoder network of a preprocessing network, the source image and a cover image;
generating, by the steganography encoder network, a steganography image comprising the cover image with the source image embedded in the cover image, the source image being at least partly visually hidden within the cover image;
extracting, by a steganalysis decoder network of the preprocessing network, the source image from the steganography image; and
generating, by the steganalysis decoder network, the lower entropy image based on the source image.

10. The method of claim 9, wherein generating the lower entropy image comprises removing the second set of style information from the source image, wherein the steganalysis decoder network comprises a neural network, and wherein the neural network generates the lower entropy image using a steganalysis algorithm.

11. The method of claim 10, further comprising:
after generating the lower entropy image, compressing the lower entropy image; and
sending the compressed lower entropy image to the deep postprocessing network.

12. An apparatus comprising:
at least one memory; and
one or more processors implemented in circuitry and configured to:
receive a lower entropy image comprising a first version of a source image, the lower entropy image having a reduced entropy relative to the source image and a compressed state relative to the source image;
decompress the lower entropy image;
identify a first set of style information having a similarity to a second set of style information missing from the lower entropy image, the second set of style information comprising style information included in the source image and removed from the lower entropy image; and
generate a higher entropy image comprising the lower entropy image modified to include the first set of style information.

13. The apparatus of claim 12, wherein the one or more processors are configured to:
classify the higher entropy image as a real image or a fake image.

14. The apparatus of claim 13, wherein the one or more processors are configured to:
when the higher entropy image is classified as the real image, output the higher entropy image.

15. The apparatus of claim 13, wherein the one or more processors are configured to:
when the higher entropy image is classified as the fake image, generate a new higher entropy image comprising the lower entropy image modified to include a third set of style information having a further similarity to the second set of style information missing from the lower entropy image; and
classify the new higher entropy image as the real image or the fake image.

16. The apparatus of claim 12, wherein the style information comprises at least one of color information, texture information, image temperature information, information about one or more image edges, background image data, illumination information, and one or more visual image details.

17. The apparatus of claim 12, wherein identifying the first set of style information having the similarity to the second set of style information comprises learning the first set of style information from one or more different images, and wherein generating the higher entropy image comprises adding the first set of style information learned from the one or more different images to the lower entropy image.

18. The apparatus of claim 12, wherein identifying the first set of style information having the similarity to the second set of style information comprises learning the first set of style information from one or more different images, the first set of style information being learned without at least one of reference to the source image and interacting with an encoder that coded at least one of the source image and the lower entropy image.

19. The apparatus of claim 12, wherein generating the higher entropy image comprises increasing an entropy of the lower entropy image by adding the first set of style information to the lower entropy image, wherein the first set of style information is learned by analyzing a dataset of images having one or more statistical properties selected based on one or more properties of the lower entropy image.

20. The apparatus of claim 12, wherein the one or more processors are configured to:
obtain the source image and a cover image;
generate a steganography image comprising the cover image with the source image embedded in the cover image, the source image being at least partly visually hidden within the cover image;
extract the source image from the steganography image; and
generate the lower entropy image based on the source image.

21. The apparatus of claim 20, wherein generating the lower entropy image comprises removing the second set of style information from the source image, wherein the lower entropy image is generated via a neural network of a steganalysis decoder network, and wherein the neural network generates the lower entropy image using a steganalysis algorithm.

22. The apparatus of claim 21, wherein the higher entropy image is generated via a deep postprocessing network, wherein the one or more processors are configured to:
after generating the lower entropy image, compress the lower entropy image; and
provide the compressed lower entropy image to the deep postprocessing network.

23. A non-transitory computer-readable storage medium having stored thereon instructions that, when executed by one or more processors, cause the one or more processors to:
receive, via a deep postprocessing network, a lower entropy image comprising a first version of a source image, the lower entropy image having a reduced entropy relative to the source image and a compressed state relative to the source image;
decompress the lower entropy image;
identify, via a generator network of the deep postprocessing network, a first set of style information having a similarity to a second set of style information missing from the lower entropy image, the second set of style information comprising style information included in the source image and removed from the lower entropy image; and
generate, via the generator network of the deep postprocessing network, a higher entropy image comprising the lower entropy image modified to include the first set of style information.

24. The non-transitory computer-readable storage medium of claim 23, further comprising:
classifying, by a discriminator network of the deep postprocessing network, the higher entropy image as a real image or a fake image.

25. The non-transitory computer-readable storage medium of claim 24, further comprising:
when the higher entropy image is classified as the real image, outputting the higher entropy image.

26. The non-transitory computer-readable storage medium of claim 24, further comprising:
when the higher entropy image is classified as the fake image, generating, by the generator network, a new higher entropy image comprising the lower entropy image modified to include a third set of style information having a further similarity to the second set of style information missing from the lower entropy image; and
classifying, by the discriminator network, the new higher entropy image as the real image or the fake image.

27. The non-transitory computer-readable storage medium of claim 23, wherein the style information comprises at least one of color information, texture information, image temperature information, information about one or more image edges, background image data, illumination information, and one or more visual image details.

28. The non-transitory computer-readable storage medium of claim 23, wherein identifying the first set of style information having the similarity to the second set of style information comprises learning the first set of style information from one or more different images, and wherein generating the higher entropy image comprises adding the first set of style information learned from the one or more different images to the lower entropy image.

29. The non-transitory computer-readable storage medium of claim 23, wherein identifying the first set of style information having the similarity to the second set of style information comprises learning the first set of style information from one or more different images, the first set of style information being learned without at least one of reference to the source image and interacting with an encoder that coded at least one of the source image and the lower entropy image.

30. The non-transitory computer-readable storage medium of claim 23, wherein generating the higher entropy image comprises increasing an entropy of the lower entropy image by adding the first set of style information to the lower entropy image, wherein the first set of style information is learned by analyzing a dataset of images having one or more statistical properties selected based on one or more properties of the lower entropy image.
